(19) United States
(12) Patent Application Publication
(10) Pub. No.: US 2009/0309650 A1
(43) Pub. Date: Dec. 17, 2009

(54) Booster circuit

(75) Inventors: Yuji Fujita, Shiga (JP); Yuri Honda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kanagawa (JP)

(21) Appl. No.: 12/453,340

(22) Filed: May 7, 2009

(30) Foreign Application Priority Data
Jun. 17, 2008 (JP) 2008-158276

(51) Int. Cl. H02M 3/07

(52) U.S. Cl. 327/589

(57) ABSTRACT

A booster circuit includes a first capacitance device and a switch which makes a first node and a one end of the first capacitance device conductive or non-conductive in response to a first control signal. The booster circuit applies a voltage, which is applied to the first node, to the one end of the first capacitance device and charges the first capacitance device according to the voltage applied to the first node and a potential of the one end of the first capacitance device is boosted in response to a second control signal thereafter, where the second control signal is applied to an other end of the charged first capacitance device.

### BACKGROUND

1. Field of the Invention

The present invention relates to a booster circuit.

2. Description of Related Art

In general, various kinds of booster circuits are used in electronic equipments operated with low voltage power supply, such as a battery. The booster circuits boost the input low voltage power supply to a voltage which enables the electric equipments to operate properly. For such booster circuits, there is a charge pump circuit, which is composed of a plurality of diodes and capacitors and is widely used in semiconductor integrated circuits.

FIG. 9 illustrates a charge pump booster circuit 1. As shown in FIG. 9, the booster circuit 1 includes diodes D1 to D5 and capacitors C1 to C5. One terminal of the capacitors C1 to C5 are respectively connected to nodes a1 to a5. A control signal S1 is input to the other terminals of the capacitors C1 and C3. A control signal S2 is input to the other terminals of the capacitors C2 and C4. The other terminal of the capacitor C5 is connected to a ground potential GND.

An operation of the booster circuit 1 is explained with reference to FIG. 10. FIG. 10 is a timing chart showing the operation of the booster circuit 1. As shown in FIG. 10, potentials of control signals S1 and S2 repeats to be a power supply voltage VDD and the ground potential GND at a predetermined frequency. However, the periods of the power supply voltage VDD and the ground potential GND differ between the control signals S1 and S2.

The control signal S1 is at the ground potential GND from the time t1 to t2. At this time, the capacitor C1 is charged with a current flowing from the power supply voltage VDD through the diode D1. The charging voltage at this time, which is the voltage of a node a1, is indicated as VDD−VF, where VF represents a forward voltage drop of the diode D1.

Next, the control signal S1 is at the power supply voltage VDD from the time t2 to t3. At this time, the potential of the other terminal of the capacitor C1 becomes the power supply voltage VDD. Therefore, the potential of one terminal of the capacitor C1, which is the potential of the node a1, increases to 2VDD−VF. The potential of the control signal S2 at this time is the ground potential GND. Therefore, the capacitor C2 is charged with the current flowing through the diode D2. The charging voltage at this time, which is the voltage of the node a1, is indicated as VDD−VF, where VF represents a forward voltage drop of the diode D1.

The control signal S2 is at the power supply voltage VDD from the time t3 to t4. At this time, the potential of the other terminal of the capacitor C2 becomes the power supply voltage VDD. Therefore, the potential of one terminal of the capacitor C2, which is the potential of a node a2, increases to 3VDD−2VF. The capacitors C3 to C5 are charged by the similar operations as above. Then, the potentials of nodes a3 to a5 also increase more than the voltages of the nodes of the preceding stages. Eventually, the voltage of the node a5, which is an output voltage Vout, becomes 5VDD−5VF.

As described so far, the charge pump booster circuit 1 can be realized by a relatively simple circuit configuration. The booster circuit 1 has an advantage that a desired voltage can be easily obtained by adjusting the number of circuit stages. However, the booster circuit 1 also has a disadvantage that it requires more stages if the input power supply voltage VDD such as a battery is low, as only VDD−VF can be boosted by one stage.

The technique to solve such problem is disclosed in Japanese Unexamined Patent Application Publication No. 2003-45193. A booster circuit 2 disclosed in Japanese Unexamined Patent Application Publication No. 2003-45193 is shown in FIG. 11. As shown in FIG. 11, the booster circuit 2 includes MOSFET Q1 to Q5, capacitors C1 to C5, and inverters INV1 and INV2. The MOSFETs Q1 to Q5 are diode connected transistors, in which the drains and gates are respectively connected. Therefore, the MOSFETs Q1 to Q5 function in the similar way as the diodes D1 to D5 in FIG. 9. Control signal S2 and S1 are input respectively to the inverters INV1 and INV2. The inverters INV1 and INV2 output the control signals S3 and S4, which are inverted signals of the control signals S2 and S1, to the other terminals of the capacitors C3 and C4. Further, the power supply voltage of the inverter INV1 is the voltage of the node a1, and the power supply voltage of the inverter INV2 is the voltage of the node a2.

An operation of the booster circuit 2 is explained with reference to FIG. 12. FIG. 12 is a timing chart showing the operation of the booster circuit 2. Basic operations are the same as those of FIG. 10. However, the capacitors C3 and C4 are driven at a voltage higher than the power supply voltage VDD by the control signals S4 and S3. The reason for this is described below. First, the control signal S3 uses the potential of the node a1 as the power supply voltage of the inverter INV1. Therefore, the control signal S3 switches to be the voltage 2VDD−VDS and the ground voltage GND. Similarly, the control signal S4 uses the potential of the node a2 as the power supply voltage of the inverter INV1. Therefore, the control signal S4 switches to be the voltage 3VDD−2VDS and the ground voltage GND. “VDS” here represents the voltage between a drain and a source of the diode connected MOSFETs Q1 to Q5. Therefore, the value of VDS is usually equivalent to a threshold voltage of the MOSFETs, which is approximately 0.5V to 1.5V.

As a result, the potential of the node a5, which is the output voltage Vout, is indicated as 8VDD−8VDS. That is, when “VF” in FIG. 10 and abovementioned “VDS” are the same values, the output voltage Vout of the booster circuit 2 is to be the voltage higher by the amount of 3VDD−3VDS than the output voltage Vout of the booster circuit 1.

### SUMMARY

However, in the booster circuit 2 disclosed in Japanese Unexamined Patent Application Publication No. 2003-45193, the charging voltage of each capacitor is reduced by the amount of the voltage drop of the MOSFETs which are diode connected. Therefore, if the voltage of the battery used as the power supply is almost same as the abovementioned VDS, one stage can boost only a small voltage, thereby requiring many stages in order to obtain a desired voltage. The present inventor has found the problem that the circuit size increases as with the problem of the booster circuit 1.

A first exemplary aspect of an embodiment of the present invention is a booster circuit which includes a first capacitance device and a switch which makes a first node and a one end of the first capacitance device conductive or non-conductive in response to a first control signal. The booster circuit applies a voltage, which is applied to the first node, to the one end of the first capacitance device and charges the first capacitance device according to the voltage applied to the first node, and a potential of the one end of the first capacitance device is boosted in response to a second control signal thereafter, where the second control signal is applied to an other end of the charged first capacitance device.

According to the present invention, if the voltage applied to the first node is applied to the one end of the first capacitance device in order to charge the first capacitance device, the first capacitance device is charged via the switch which switches conductive or non-conductive state. Therefore, the charging voltage, which is charged for the first capacitance device, will not be reduced due to a voltage drop or the like in diodes. This enables to reduce the stages of the booster circuits to obtain a desired output voltage.

The present invention enables to suppress from increasing the circuit size.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 an example of the configuration of a booster circuit according to a first exemplary embodiment of the present invention;

FIG. 2 is an example of a generation circuit of a control signal according to the first exemplary embodiment of the present invention;

FIG. 3 a timing chart of an operation of the booster circuit according to the first exemplary embodiment of the present invention;

FIG. 4 an example of the configuration of a booster circuit according to a second exemplary embodiment of the present invention;

FIG. 5 is a timing chart of an operation of the booster circuit according to the second exemplary embodiment of the present invention;

FIG. 6 is an example of the configuration of a booster circuit according to a third exemplary embodiment of the present invention;

FIG. 7 is a timing chart of an operation of the booster circuit according to the third exemplary embodiment of the present invention;

FIG. 8 is an example of the configuration of a booster circuit according to the third exemplary embodiment of the present invention;

FIG. 9 is an example of the configuration of a booster circuit of a related art;

FIG. 10 is a timing chart of an operation of the booster circuit of the related art;

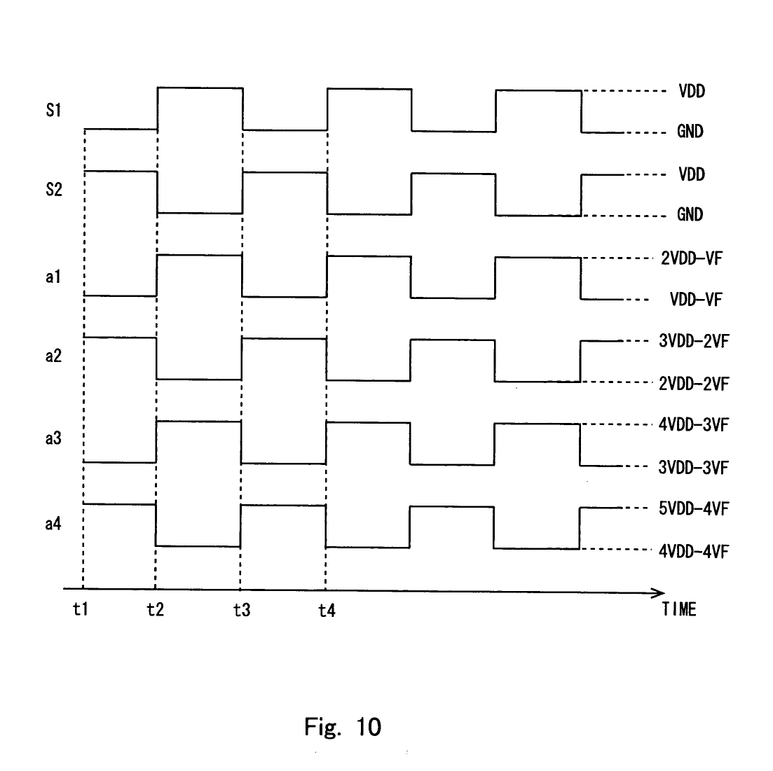

FIG. 11 is an example of the configuration of the booster circuit of the prior art; and

FIG. 12 is a timing chart of an operation of the booster circuit of the prior art.

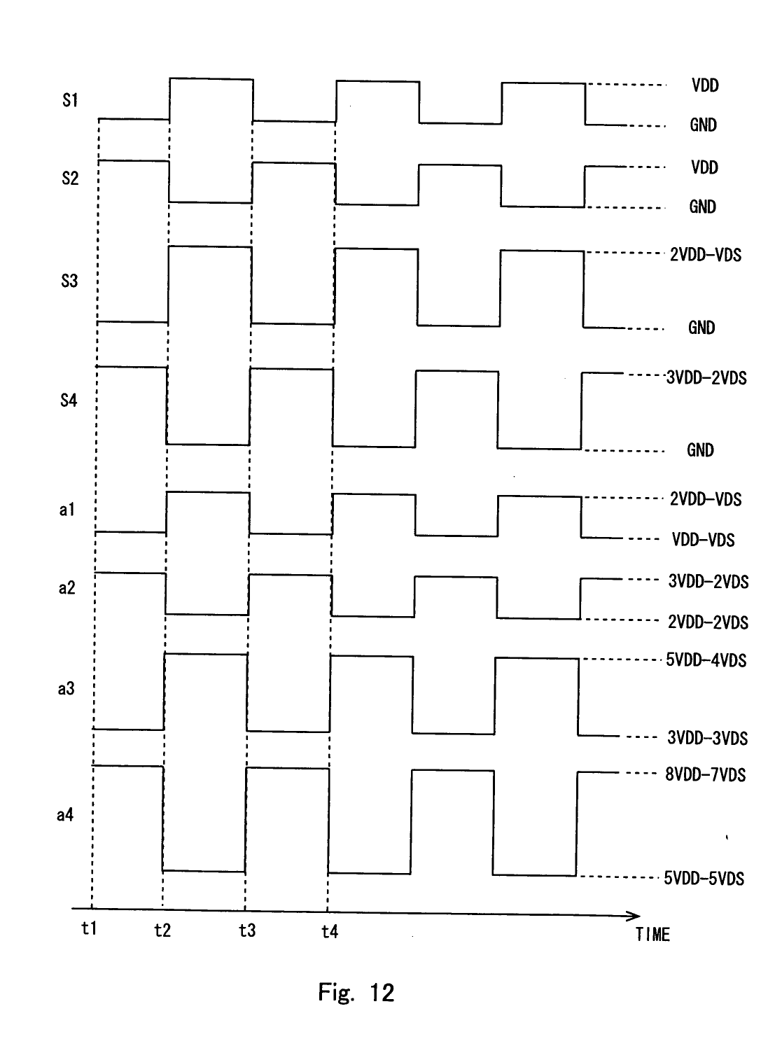

### DETAILED DESCRIPTION OF THE EXEMPLARY EMBODIMENTS

### First Exemplary Embodiment

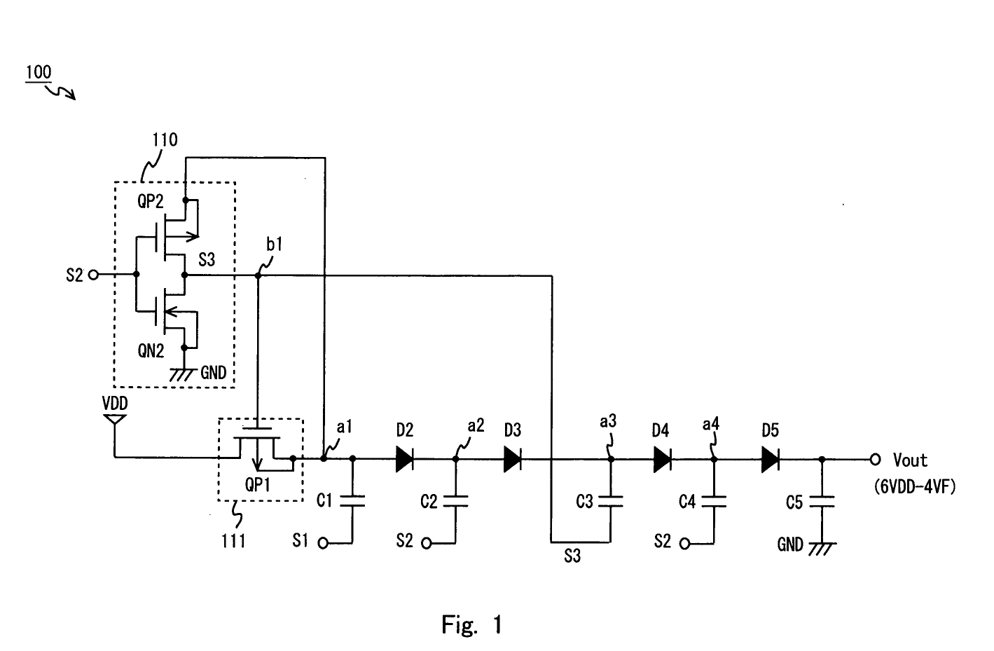

A first exemplary embodiment incorporating the present invention is described hereinafter in detail with reference to the drawings. An example of the configuration of a booster circuit 100 according to this embodiment is shown in FIG. 1. As shown in FIG. 1, the booster circuit 100 includes capacitance devices C1 to C5, diodes D2 to D5, a control signal generation circuit 110, and a switch 111. The switch 111 includes a PMOS transistor QP1.

As for the PMOS transistor QP1, a drain is connected to the power supply voltage terminal VDD, a source is connected to a node a1, and a gate is connected to a node b1.

Each of the diodes D2 to D5 includes a forward voltage drop VF. As for the diode D2, an anode is connected to the node a1 and a cathode is connected to the node a2. As for the diode D3, an anode is connected to the node a2 and a cathode is connected to the node a3. As for the diode D4, an anode is connected to the node a3 and a cathode is connected to the node a4. As for the diode D5, an anode is connected to the node a4 and a cathode is connected to the output terminal Vout. It is noted that the power supply voltage terminal VDD supplies the power supply voltage VDD. For convenience, the code of the output terminal “Vout” represents the name of the terminal as well as the potential of the output terminal.

The control signal generation circuit 110 includes a PMOS transistor QP2 and an NMOS transistor QN2. The PMOS transistor QP2 and the NMOS transistor QN2 make up an inverter. As for the PMOS transistor QP2, a source is connected to the node al and a drain is connected to the node b1. As for the NMOS transistor QN2, a source is connected to a ground voltage terminal GND, and a drain is connected to the node b1. It is noted that the ground voltage terminal GND supplies the ground voltage GND. The control signal S2 is input to the gates of the PMOS transistor rQP2 and the NMOS transistor QN2. The inverter, which is made up of the PMOS transistor QP2 and the NMOS transistor QN2, inputs the control signal S2 and outputs the control signal S3 to the node b1. This inverter operates with the potential of the node a1 as the power supply voltage.

As for the capacitance device C1, one end is connected to the node a1, and the control signal S1 is input to the other end. As for the capacitance device C2, one end is connected to the node a2, and the control signal S2 is input to the other end. As for the capacitance device C3, one end is connected to the node a1, and the other end is connected to the node b1. Accordingly, the control signal S3 is input to the other end of the capacitance device C3. As for the capacitance device C4, one end is connected to the node a4, and the control signal S2 is input to the other end. As for the capacitance device C5, one end is connected to the output terminal Vout, and the other end is connected to the ground voltage terminal GND.

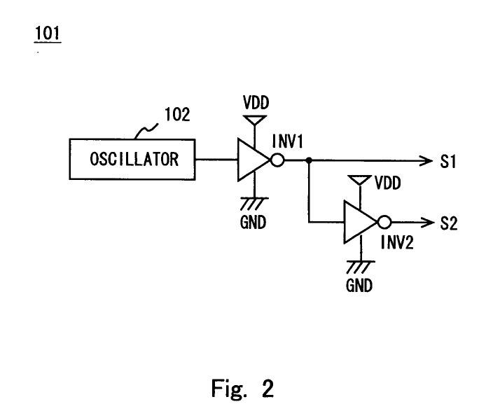

FIG. 2 shows an example of a basic control signal generation circuit 101 which generates the control signals S1 and S2. As shown in FIG. 2, the basic control signal generation circuit 101 includes an oscillator 102, and inverters INV1 and INV2. The oscillator 102 outputs clock signals of a predetermined frequency. The inverter INV1 inverts and buffers the output clock signal from the oscillator 102. The inverter INV2 inverts and buffers the control signal S1. As described above, the control signals S1 and S2 are buffered by the inverters INV1 and INV2. Therefore, the capacitive load, which is the destination of the control signals S1 and S2, can be fully driven. Further, the potential levels of the control signals S1 and S2 repeat the ground voltage GND and the power supply voltage VDD at a predetermined frequency. The control signals S1 and S2 are signals of reversed phase with which the timings of the period of the ground voltage GND and the power supply voltage VDD differ from each other. It is noted that the configuration of the basic control signal generation circuit 101 may be different from the circuit configuration shown in FIG. 2, as along as the circuit can obtain the abovementioned control signals S1 and S2.

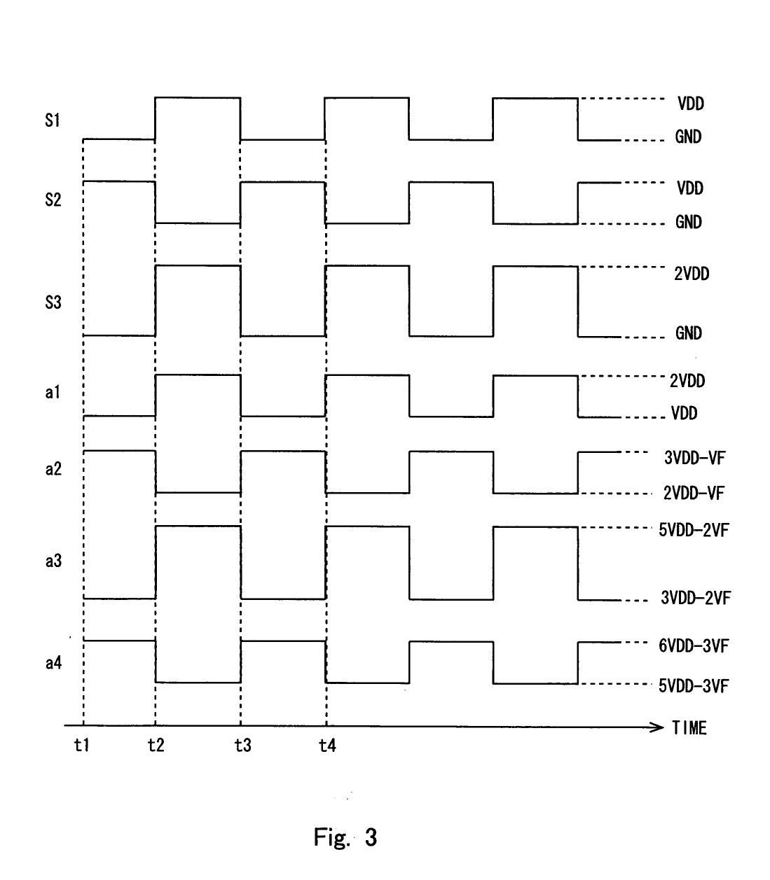

The operation of the booster circuit 100 is explained in detail with reference to the drawings. An example of the timing chart of the operation of the booster circuit 100 according to this embodiment is shown in FIG. 3. It is noted that the capacitance devices C1 to C5 are assumed to be fully charged at the time of charging.

As shown in FIG. 3, the control signal S1 is at the ground voltage GND in the period from the time t1 to t2. At this time, the control signal S2 becomes the power supply voltage VDD. Accordingly, in the control signal generation circuit 110, the PMOS transistor QP2 is turned off and the NMOS transistor QN2 is turned on. Therefore, the control signal S3 becomes the ground voltage GND.

As the control signal S3 is at the ground voltage GND, the PMOS transistor QP1 is also turned on. Thus, the power supply voltage terminal VDD and the node a1, which is one end of the capacitance device C1, are made to be conductive. On the other hand, as the control signal S1 is input to the other end of the capacitance device C1, the ground voltage GND is applied in the period from the time t1 to t2. Therefore, a potential difference between the both ends is VDD and a charge corresponding to the potential difference is charged to the capacitance device C1.

Next, the control signal S1 becomes the power supply voltage VDD at the time t2. As the control signal S1 becomes the power supply voltage VDD, the potential of the node al increases to 2VDD. However, in the control signal generation circuit 110, the PMOS transistor QP2 is turned on and the NMOS transistor QN2 is turned off at the same time. Accordingly, the node a1 and the node b1 are made to be conductive to be the same potential, which is 2VDD. Therefore, the PMOS transistor QP1 is turned off. Then, a current flows from the node a1, which has a potential increased to 2VDD, to one end of the capacitance device C2 (node a2) through the diode D2. The capacitance device C2 is charged with this current. The control signal S2 is at ground voltage GND in the period from the time t2 to t3. Thus, the capacitance device C2 is charged according to the potential difference between the potential of the node a2 and the ground voltage GND. Further, the potential of the node a2 is the potential calculated by subtracting the forward voltage drop VF of the diode D2 from the potential 2VDD of the node a1. From the above explanation, the capacitance device C2 is charged with the potential difference of 2VDD−VF of both ends.

The charging voltages of the capacitance devices C3 and C4, which are the potentials of the nodes a3 and a4, also increase by similar operations. However, as for the capacitance device C3, the other end is connected to the node b1 and the control signal S3 is input thereto. The boosted voltage of the capacitance device C3, which is the potential of the node a3, is described hereinafter.

The control signal S2 becomes the power supply voltage VDD at the time t3. The potential of the other end of the capacitance device C2 increases by the amount of the power supply voltage VDD. Thus one end of the capacitance device C2, which is the potential of the node a2, increases from 2VDD−VF to 3VDD−VF. On the other hand, in the control signal generation circuit 110, the PMOS transistor QP2 is turned off and the NMOS transistor QN2 is turned off. Therefore, the control signal S3, which is the potential of the node b1, becomes the ground voltage GND. Thus, a current flows from the node a2, which has a potential increased to 3VDD−VF, to one end of the capacitance device C3 (node a3) through the diode D3. Then, the capacitance device C3 is charged. It is noted that the capacitance device C3 is charged with the potential difference of 3VDD−2VF, which is calculated by subtracting the voltage drop VF of the diode D3.

Next, the control signal S2 becomes the ground potential GND at the time t4. Therefore, in the control signal generation circuit 110, the PMOS transistor QP2 is turned on and the NMOS transistor QN2 is turned off. As described above, the nodes a1 and b1 are made to be conductive, thereby increasing the potential of the other end of the capacitance device C3 increases to 2VDD. This makes one end of the capacitance device C3, which is the potential of the node-a3, increase to 5VDD−2VF. The capacitance device C4 operates in a similar way as the capacitance device C2. Thus the detailed explanation of the operation is omitted here.

Consequently, the potential Vout of the output terminal Vout will be 6VDD−4VF. The other end of the capacitance device C5 is connected to the ground voltage GND. The capacitance device C5 operates as a smoothing capacitor regardless of the boosting operation.

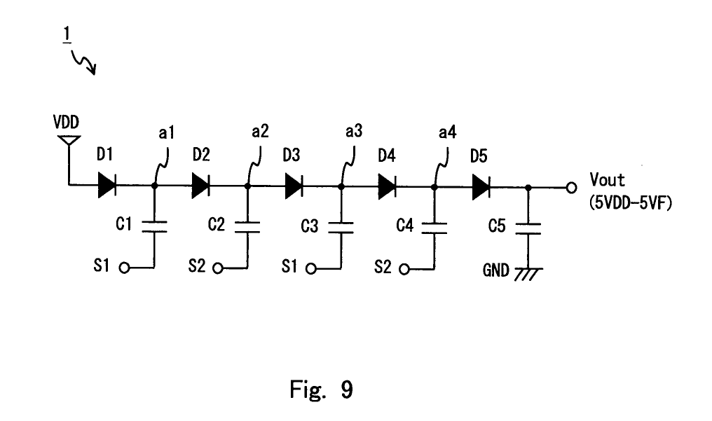

As described above, the booster circuit 100 of the first exemplary embodiment uses the PMOS transistor QP1 as a switch. This enables to boost the output voltage Vout by the amount of the voltage drop VF, which is the voltage drop of the diode, than the booster circuit 1 of the related art shown in FIG. 9. Further, the control signal S3, which is an output of the control signal generation circuit 100, is applied to the other end of the capacitance device C3 to drive the capacitance device C3. This enables to boost the node a3 by the amount of VDD more than the booster circuit 1. Therefore, the output voltage Vout, which is higher by the amount of VDD+VF in total, can be obtained. Conversely, the circuit requires less stages than the booster circuit 1 in order to boost to a desired output voltage, thereby realizing to miniaturize the circuit.

In a specific example, suppose that VDD is 2V, the potential Vout of the booster circuit 1 can achieve 5×2.0−5×0.6=7V. However, the potential Vout of the booster circuit 100 of FIG. 1 can achieve 6×2.0−4×0.6=9.6V, which is higher by 2.6V with the same number of stages. If the desired output voltage is 7V, the booster circuit 1 requires 5 stages of charge pump circuits. In the booster circuit 100, the diode D4 and the capacitance device C4, which are illustrated in FIG. 1, can be eliminated. Even in this case, the output voltage of 5Vdd−3VF=8.2V can be obtained, thereby realizing to reduce the number of circuit devices and increasing the output voltage.

It is noted that if the control signals S1 and S2 are driven by another high voltage other than VDD, the same effect can be achieved as the control signal S3 becomes higher.

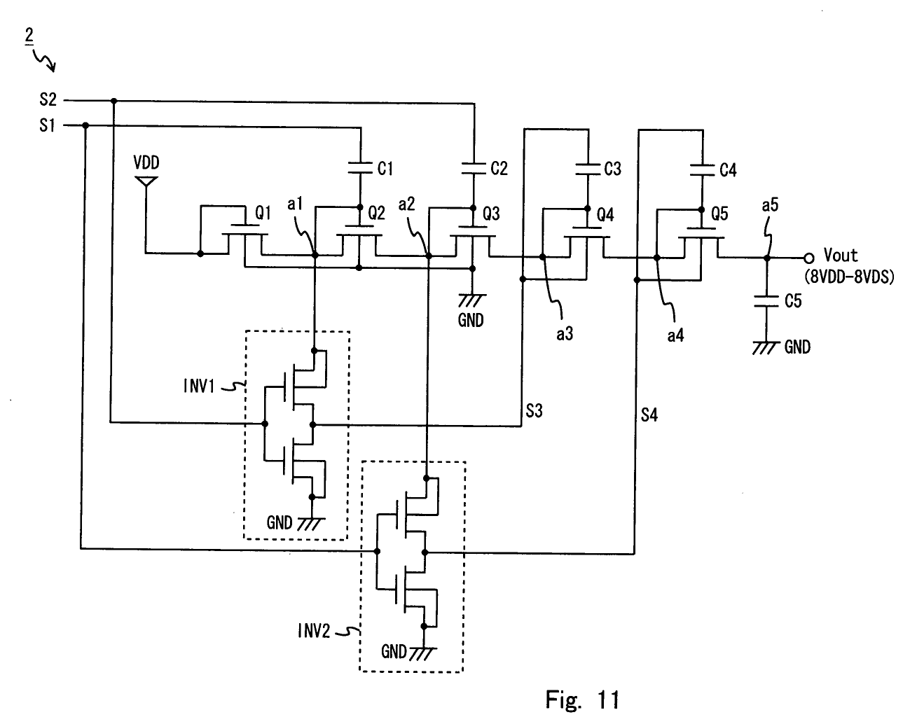

Further, in the booster circuit 2 of FIG. 11, the output voltage is 8VDD−8VDS. Therefore, if the power supply voltage VDD is almost same as VDS, the output voltage cannot be boosted or can be boosted by an extremely small voltage. Even in such case, the booster circuit 100 can ensure to achieve the boosted voltage of 6VDD−4VF (where VF=VDS).

The electrostatic capacitance values of the abovementioned capacitance devices C1 to C5 are assumed to be much larger than the output current. For example, if the capacitance devices C1 to C5 are made up of multilayer ceramic capacitors or the like, the size of the capacitance devices are almost the same with the electrostatic capacitance value approximately from 1 pF to 100 pF. Therefore, capacitance devices having much larger electrostatic capacitance values than the output current can be used. However, in order to realize the booster circuit 100 of the present invention by one chip of semiconductor integrated circuit including capacitance devices, the electrostatic capacitance values of the capacitance device largely influence the area of the chip. This requires to set to the minimum electrostatic capacitance value according to the output.

Hereinafter, the comparison is made between the case of realizing the booster circuit 100 by one chip of semiconductor integrated circuit and the booster circuit 1 of the related art in regard to the electrostatic capacitance values of the capacitance devices. It is noted that the last stage capacitance device C5 is a smoothing capacitor, thus the comparison is made using the total capacitance of the capacitance devices except the capacitance device C5. For convenience, the codes of the capacitance devices “C1” to “C4” represent the element names as well as their electrostatic capacity.

In the booster circuit 1, suppose that the minimum electrostatic capacitance of the capacitance devices according to the output is Cm, it can be said that C1=C2=C3=C4=Cm. Thus the total capacitance of the capacitance devices is 4 Cm. On the other hand, in the booster circuit 100 of the present invention, it can be said that C2=C3=C4=Cm. However C1 is required for charging C3 in addition to C2, it is C1=C2+C3=2 Cm. Thus the total capacitance of capacitance devices is C1+C2+C3+C4=5 Cm. Accordingly, in the booster circuit 100 of the present invention, the total capacitance of the capacitance devices increases by the amount of Cm as compared to the booster circuit 1 of the related art. Therefore, one stage must be removed in order to have the same electrostatic capacitance as the booster circuit 1. However, as described above, the booster circuit 100 of the present invention can achieve the output voltage higher by 2VF even if one stage is removed. Therefore, the above problem can be solved by removing one stage in order to avoid an increase in the chip size. As described so far, even when attempting to realize the present invention by a semiconductor integrated circuit, the effects such as a higher output voltage and a reduced chip area can be achieved.

### Second Exemplary Embodiment

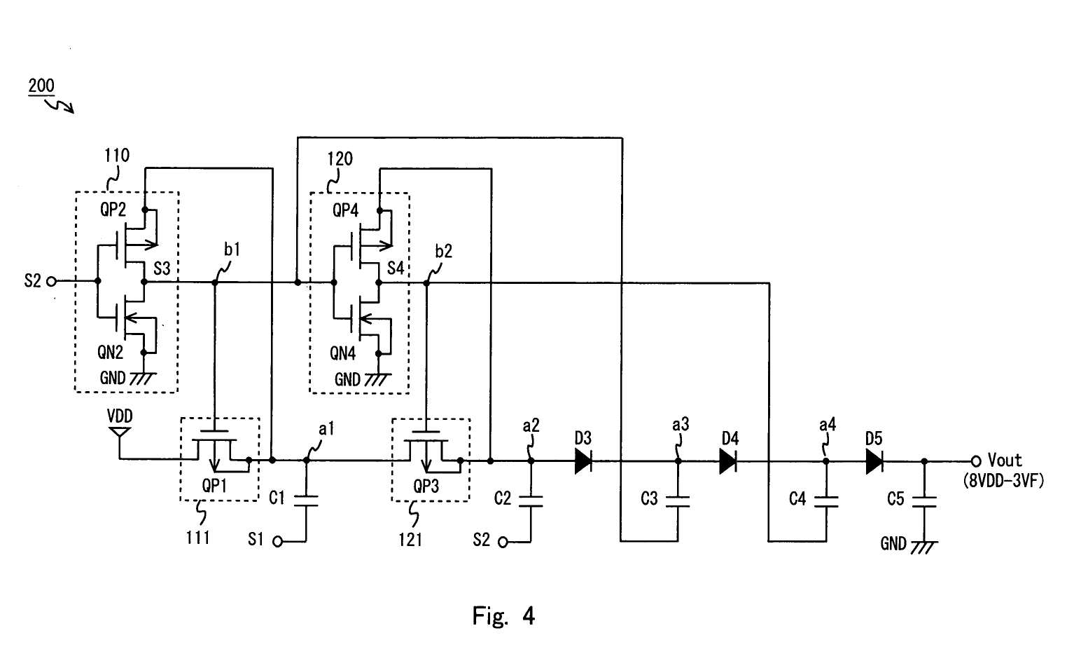

A second exemplary embodiment incorporating the present invention is described in detail with reference to the drawings. An example of the configuration of a booster circuit 200 according to this embodiment is shown in FIG. 4. As shown in FIG. 4, the booster circuit 200 includes capacitance devices C1 to C5, diodes D3-D5, control signal generation circuits 110 and 120, and switches 111 and 121. In FIG. 4, components identical or similar to those in FIG. 1 are denoted by reference numerals identical or similar to those therein. The differences from the first exemplary embodiment are that the control signal generation circuit 120 is added and the diode D2 is replaced with the switch 121. Therefore, only those differences are described in the explanation of the second exemplary embodiment.

The control signal generation circuit 120 includes a PMOS transistor QP4 and an NMOS transistor QN4. The PMOS transistor QP4 and the NMOS transistor QN4 make up an inverter. As for the PMOS transistor QP4, a source is connected to the node a2 and a drain is connected to the node b2. As for the NMOS transistor QN4, a source is connected to the ground voltage terminal GND and a drain is connected to the node b2. The control signal S3 is input to the gates of the PMOS transistor QP4 and the NMOS transistor QN4. The inverter, which is made up of the PMOS transistor QP4 and the NMOS transistor QN4, inputs the control signal S3 and outputs the control signal S4 to the node b2. This inverter operates with the potential of the node a2 as the power supply voltage. Further, the node b2 is connected with the other end of the capacitance device C4. That is, the control signal S4 is input to the other end of the capacitance device C4.

The switch 121 includes a PMOS transistor QP3. As for the PMOS transistor QP3, a drain is connected to the node a1, a source is connected to the node a2, and a gate is connected to the node b2. That is, the control signal S4 is input also to the gate of the PMOS transistor QP3.

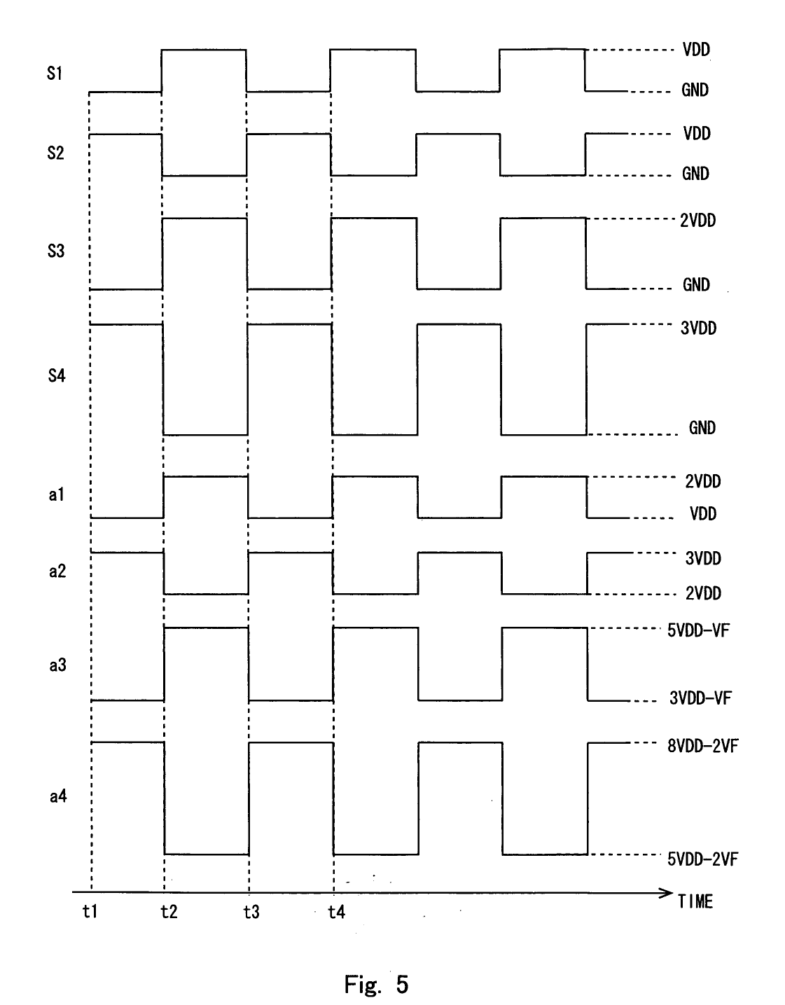

Hereinafter, an operation of the booster circuit 200 is explained in detail with reference to the drawings. An example of the timing chart of the operation of the booster circuit 200 according to the second exemplary embodiment is shown in FIG. 5. The operation by the booster circuit 200 is fundamentally the same as the operation of the booster circuit 100 which is explained in the first exemplary embodiment. Accordingly, only the differences from the first exemplary embodiment are described here.

As shown in FIG. 5, the potential of the control signal S3, which is output from the control signal generation circuit 110, is 2VDD in the period from the time t2 to t3, for example. Therefore, in the control signal generation circuit 120, the PMOS transistor QP4 is turned off and the NMOS transistor QN4 is turned on. Thus, the control signal S4 output from the control signal generation circuit 120 becomes the ground potential GND. Further, as the control signal S4 becomes the ground potential GND, the PMOS transistor QP3 is turned on to make the nodes a1 and a2 be conductive. On the other hand, as the control signal S3 becomes 2VDD, the PMOS transistor QP1 is turned off, thereby blocking the power supply voltage terminal VDD and the node a1. Thus, a current flows from the node a1, which has a potential increased to 2VDD, to one end of the capacitance device C2 (node a2) through the PMOS transistor QP3. Then, the capacitance device C2 is charged. The diode D2 in the booster circuit 100 is replaced with the PMOS transistor QP3 in the booster circuit 200. Thus the forward voltage drop VF of the diode is removed. Accordingly, the capacitance device C2 is charged with the potential difference of 2VDD. Then, the control signal S2 becomes VDD at the time t3 and the node a2 increases to 3VDD. Subsequent operations are the same as those of the first exemplary embodiment.

The other end of the capacitance device C4 is connected with the node b2. As described above, the control signal S4 is at the ground potential GND in the period from the time t2 to t3. Therefore, the potential of the other end of the capacitance device C4 is also the ground voltage GND. At this time, the potential of the node a3 has increased to 5VDD−VF. A current flows from the node a3 to one end of the capacitance device C4 (node a4) through the diode D4. Then, the capacitance device C4 is charged with the potential difference 5VDD−2VF of both ends.

Next, the control signal S3 becomes 2VDD at the time t3. Thus the PMOS transistor QP4 is turned on and the NMOS transistor QN4 is turned off. Therefore, the nodes a2 and b2 are made to be conductive and the control signal S4 becomes 3VDD. Accordingly, the other end of the capacitance device C4 increases to 3VDD. This increases one end of the capacitance device C4, which is the potential of the node a4, to 8VDD−2VF. Then, the capacitance device C5 as a smoothing capacitor is charged. Consequently, the potential Vout of the output terminal Vout will be the potential of 8VDD−3VF.

As described above, in the booster circuit 200 of the second exemplary embodiment, the diode D2 of the booster circuit 100 according to the first exemplary embodiment is replaced with the PMOS transistor QP3. This PMOS transistor QP3 is used as a switch. This enables to remove the forward voltage drop VF of the diode in the booster circuit 100, thereby increasing the output voltage Vout. Further, the control signal S4 of the control signal generation circuit 120 is connected to the other end of the capacitance device C4 to drive the capacitance device C4. Therefore, the node a4 can be boosted by the amount of 2VDD as compared to the booster circuit 100. As a result, the output voltage Vout can be 8VDD−3VF. Thus, the output voltage Vout which is higher by 2VDD+VF in total can be obtained as compared to the booster circuit 100. This also indicates that the booster circuit 200 can obtain a higher output voltage Vout than the booster circuit 2 of the prior art explained with reference to FIG. 11 (where VF=VDS).

### Third Exemplary Embodiment

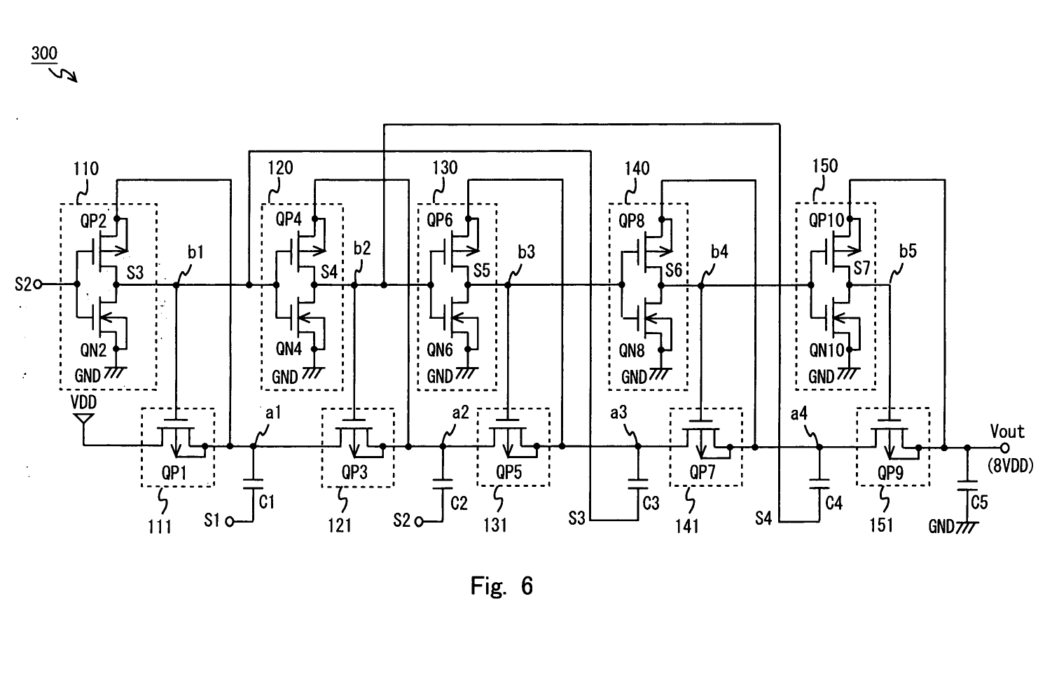

A third exemplary embodiment incorporating the present invention is described in detail with reference to the drawings. An example of the configuration of a booster circuit 300 according to this embodiment is shown in FIG. 6. As shown in FIG. 6, the booster circuit 300 includes capacitance devices C1 to C5, control signal generation circuits 110 to 150, and switches 111 to 151. In FIG. 6, components identical or similar to those in FIG. 2 are denoted by reference numerals identical or similar to those therein. The differences from the second exemplary embodiment is that the control signal generation circuits 130 to 150 are added and the diodes D3 to D5 are replaced with the switches 131 to 151. Therefore, only those differences are described in the explanation of the third exemplary embodiment.

The control signal generation circuit 130 includes a PMOS transistor QP6 and an NMOS transistor QN6. The PMOS transistor QP6 and the NMOS transistor QN6 make up an inverter. As for the PMOS transistor QP6, a source is connected to the node a3 and a drain is connected to the node b3. As for the NMOS transistor QN6, a source is connected to the ground voltage terminal GND and a drain is connected to the node b3. The control signal S4 is input to the gates of the PMOS transistor QP6 and the NMOS transistor QN6. The inverter, which is made up of the PMOS transistor QP6 and the NMOS transistor QN6, inputs the control signal S4 and outputs the control signal S5 to the node b3. This inverter operates with the potential of the node a3 as the power supply voltage.

The control signal generation circuit 140 includes a PMOS transistor QP8 and an NMOS transistor QN8. The PMOS transistor QP8 and the NMOS transistor QN8 make up an inverter. As for the PMOS transistor QP8, a source is connected to the node a4 and a drain is connected to the node b4. As for the NMOS transistor QN8, a source is connected to the ground voltage terminal GND and a drain is connected to the node b4. The control signal S5 is input to the gates of the PMOS transistor QP8 and the NMOS transistor QN8. The inverter, which is made up of the PMOS transistor QP8 and the NMOS transistor QN8, inputs the control signal S5 and outputs the control signal S6 to the node b4. This inverter operates with the potential of the node a4 as the power supply voltage.

The control signal generation circuit 150 includes a PMOS transistor QP10 and an NMOS transistor QN10. The PMOS transistor QP10 and the NMOS transistor QN10 make up an inverter. As for the PMOS transistor QP10, a source is connected to the output terminal Vout and a drain is connected to the node b5. As for the NMOS transistor QN10, a source is connected to the ground voltage terminal GND and a drain is connected to the node b5. The control signal S6 is input to the gates of the PMOS transistor QP10 and the NMOS transistor QN10. The inverter, which is made up of the PMOS transistor QP10 and the NMOS transistor QN10, inputs the control signal S6 and outputs the control signal S7 to the node b5. This inverter operates with the potential of the output terminal Vout as the power supply voltage.

The switch 131 includes the PMOS transistor QP5. As for the PMOS transistor QP5, a drain is connected to the node a2, a source is connected to the node a3, and a gate is connected to the node b3. That is, the control signal S5 is input to the gate of the PMOS transistor QP5.

The switch 141 includes a PMOS transistor QP7. As for the PMOS transistor QP7, a drain is connected to the node a3, a source is connected to the node a4, and a gate is connected to the node b4. That is, the control signal S6 is input to the gate of the PMOS transistor QP7.

The switch 151 includes a PMOS transistor QP9. As for the PMOS transistor QP9, a drain is connected to the node a4, a source is connected to the output terminal Vout, and a gate is connected to the node b5. That is, the control signal S7 is input to the gate of the PMOS transistor QP9.

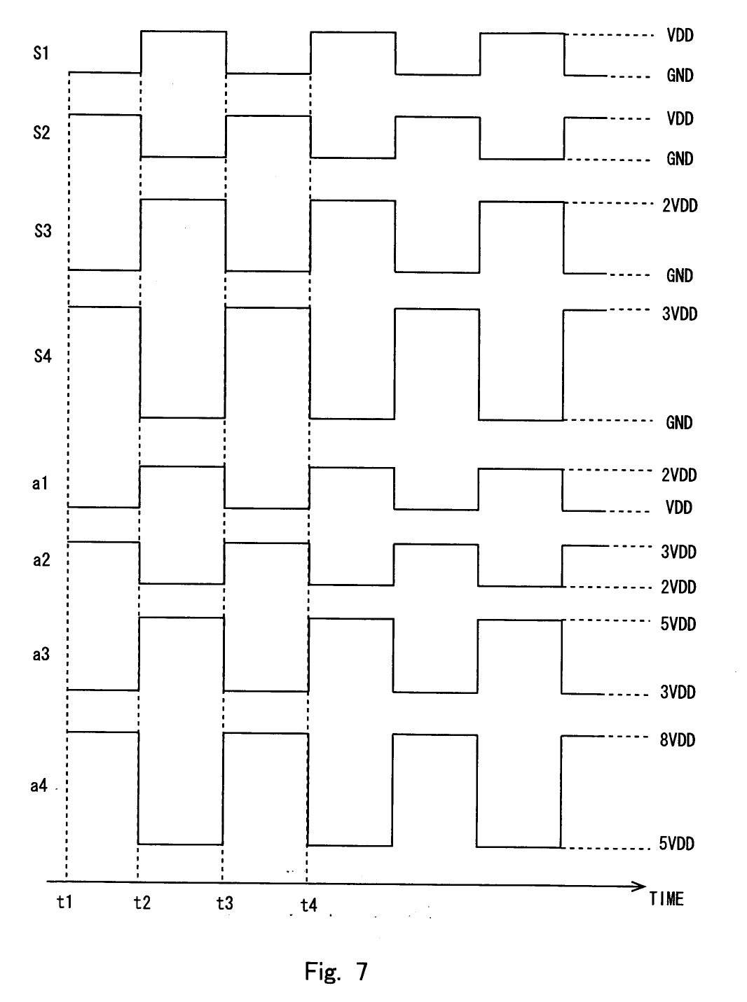

An operation of the booster circuit 300 is explained in detail with reference to the drawings. An example of the timing chart of the operation of the booster circuit 300 according to the third exemplary embodiment is shown in FIG. 7. The operation by the booster circuit 300 is fundamentally the same as the operation of the booster circuit 200 which is explained in the second exemplary embodiment. Accordingly, only the differences from the second exemplary embodiment are described here. In FIG. 7, the description of the control signals S5 to S7 is omitted. This is because that the control signals S5 to S7 do not particularly concern with the driving voltage for the capacitance devices and the control signals S5 to S7 are used only for controlling to switch on/off the PMOS transistors QP5 to QP9. Therefore, the power supply voltage of the inverters in the control signal generation circuits 130, 140 and, 150 may be supplied from the power supply voltage terminal VDD instead of the nodes a3 and a4, and the output terminal Vout.

As shown in FIG. 7, the operation of the booster circuit 300 is fundamentally the same as the booster circuit 200. However, in the booster circuit 300, the capacitance devices C3 to C5 are charged with the PMOS transistors QP5, QP7, and QP9 instead of the diodes D3 to D5. This prevents from generating voltage drops by the diodes in the charging voltage. Therefore, the booster circuit 300 can eliminate the influence of the voltage drops by the diodes for the boosted voltages of the nodes a3 and a4. Consequently, the output voltage Vout can be 8VDD. This indicates that the booster circuit 300 can obtain a higher output voltage Vout than the booster circuit 200.

The present invention is not limited to the abovementioned embodiments but may be changed without departing from the scope and spirit of the invention. For example, although PMOS transistors are used for the switches in the above exemplary embodiments, NMOS transistors may be used instead. However in that case, the circuit must be configured in a way that the logic of the control signals is reversed. Further, the MOS transistors may be composed of bipolar transistors.

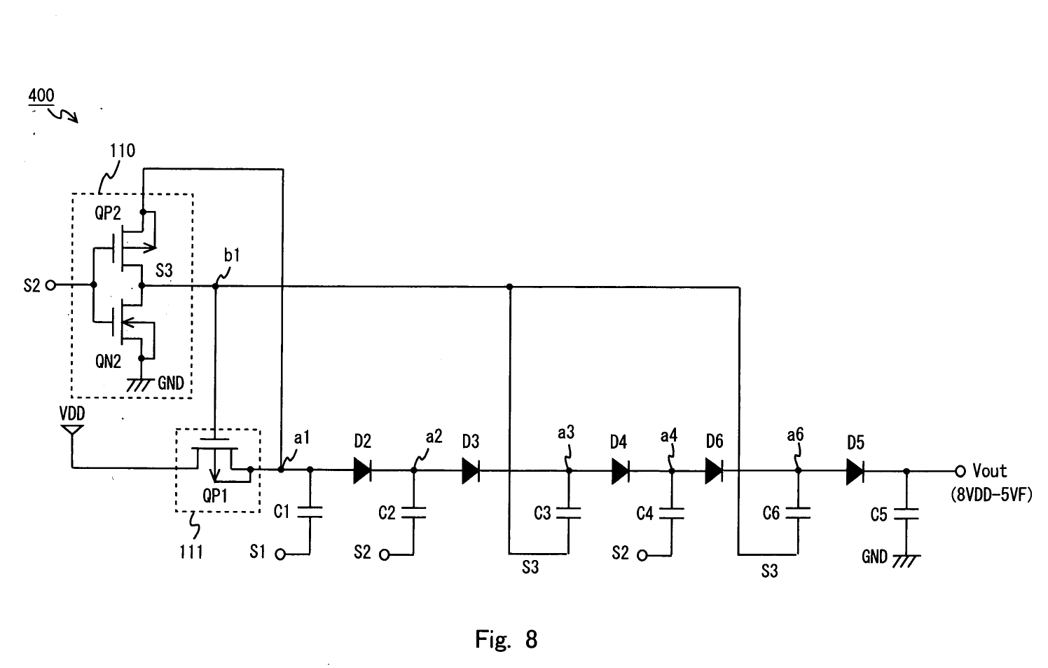

Moreover, the number of boosting stages is not limited to five, as with the abovementioned exemplary embodiments, but the stages may be increased or reduced. For example, an exemplary embodiment with increased number of stages is illustrated as a booster circuit 400 in FIG. 8. In addition to the booster circuit 100 of the first exemplary embodiment, the booster circuit 400 further includes a diode D6 connected between the node a4 and the diode D5. Further, a capacitance device C6 is connected between the node (node a6), which exists between the diodes D6 and D5, and the node b1. As for the capacitance device C6, one end is connected to the node a6 and the other end is connected to the node b1.

Therefore, at the time of boosting the node a6, which is when the control signal S3 of 2VDD is applied to the other end of the capacitance device C6, the booster circuit 400 boosts the potential of the node a6 by the amount of 2VDD. Thus, the boosted voltage at the time of the boosting the node a6, is 8VDD−4VF. As a result, the booster circuit 400 can obtain 8VDD−5VF as the output voltage Vout.

In this way, the booster circuit 400 has an additional stage for boosting the voltage as compared to the booster circuit 100. The booster circuit 400 uses the control signal S3 to boost the node a6 in the same way as for the node a3. Accordingly, although the number of boosting stages increases, the output voltage Vout can be higher than the booster circuit 100. In order to obtain the same output voltage Vout using the booster circuit 1 of the related art, many more stages than the booster circuit 400 are required. This indicates that the booster circuit 400 of this embodiment enables to obtain a high boosted voltage with a small circuit size.

In order to further increase the number of stages to boost, as with the capacitance device C6, the control signal S3 may be applied to the other ends of the capacitance devices, which are connected to each node of even numbered stages from the node a3. The number of stages of the abovementioned node a6 is the second stage from the node a3. Further, the configuration to use the control signal S3 for boosting a plurality of nodes can also be applied to the second exemplary embodiment. For example, in the booster circuit 200 with increased number of stages, the control signal S3 is applied to the other ends of the capacitance devices, which are connected to the nodes of even numbered stages from the node a3. Moreover, the control signal S4 may be applied to the other ends of the capacitance devices, which are connected to the nodes of even numbered stages from the node a4.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

The first, second and third exemplary embodiments can be combined as desirable by one of ordinary skill in the art.

What is claimed is:

1. A booster circuit comprising:
a first capacitance device; and
a switch which makes a first node and a one end of the first capacitance device conductive or non-conductive in response to a first control signal,
wherein the booster circuit applies a voltage, which is applied to the first node, to the one end of the first capacitance device and charges the first capacitance device according to the voltage applied to the first node, and
a potential of the one end of the first capacitance device is boosted in response to a second control signal thereafter, the second control signal being applied to an other end of the charged first capacitance device.

2. The booster circuit according to claim 1, wherein the switch is a transistor which inputs the first control signal to a control terminal.

3. The booster circuit according to claim 1, wherein the one end of the charged first capacitance device is boosted in response to the second control signal if the switch is non-conductive, and
the second capacitance device is charged according to a voltage of the one end of the boosted first capacitance device.

4. The booster circuit according to claim 3, wherein the second capacitance device is charged according to the voltage of the one end of the boosted first capacitance device, the voltage being applied to a one end of the second capacitance device, and
a potential of the one end of the second capacitance device is boosted in response to a third control signal thereafter, the third control signal being applied to an other end of the charged second capacitance device.

5. The booster circuit according to claim 4, further comprising:
m number of capacitance devices which are represented by a first, a second and a mth capacitance device, the capacitance devices having one ends consecutively connected and other ends input with a control signal, where m is a natural number greater or equal to 3,
wherein the first control signal is applied to an other end of a (2n+1)th capacitance device among the m number of the capacitance devices, where n is a natural number.

6. The booster circuit according to claim 5, wherein the first control signal is applied to other ends of the plurality of (2n+1)th capacitance devices, where n is a natural number.

7. The booster circuit according to claim 5, further comprising a control signal generation circuit which generates the first control signal;
wherein the control signal generation circuit takes a potential of the first control signal as the voltage of the one end of the boosted first capacitance device if a potential of the one end of the (2n+1)th capacitance device is boosted, where n is a natural number.

8. The booster circuit according to claim 7, wherein the control signal generation circuit is composed of an inverter having a high potential power supply voltage as a potential of the one end of the first capacitance device and a low potential power supply voltage as a ground voltage.

9. The booster circuit according to claim 4, wherein the booster circuit further comprises:
m number of capacitance devices which are represented by a first, a second and a mth capacitance devices, the capacitance devices having one ends consecutively connected and other ends input with a control signal, where m is a natural number greater or equal to 3; and
a kth control signal generation circuit which applies a kth control signal to an other end of an nth capacitance device among the m number of the capacitance devices, where k is a natural number greater or equal to 4 and n is a natural number greater or equal to 3.

10. The booster circuit according to claim 9, wherein the kth control signal generation circuit takes a potential of the kth control signal as a voltage of a one end of a (n−2)th capacitance device if a potential of the one end of the (n−2)th capacitance device is boosted, where k is a natural number greater than or equal to 4 and n is a natural number greater or equal to 3.

11. The booster circuit according to claim 10, wherein the kth control signal generation circuit is composed of an inverter which has a high potential power supply voltage as the potential of the one end of the (n−2)th capacitance device and a low potential power supply voltage as a ground voltage, where k is a natural number greater or equal to 4 and n is a natural number greater or equal to 3.

12. The booster circuit according to claim 1, wherein the booster circuit is realized by one chip of a a semiconductor integrated circuit.
